(19) United States
(12) Patent Application Publication
(10) Pub. No.: US 2002/0035719 A1
(43) Pub. Date: Mar. 21, 2002

(54) Method and apparatus for designing semiconductor integrated circuits

(76) Inventor: Genichi Tanaka, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 09/775,819

(22) Filed: Feb. 5, 2001

(30) Foreign Application Priority Data
Sep. 20, 2000 (JP) 2000-285584

(51) Int. Cl. G06F 17/50

(52) U.S. Cl. 716/11

(57) ABSTRACT

Layout of a semiconductor integrated circuit is designed based on predetermined designing rules. Vias are detected based on information about the layout designed. It is determined if there exists a close via. A close via is a via surrounded by vias on four sides. It is determined if there exists an equal potential via. An equal potential via is a via having a potential equal to the potential of said close via in the vias that surround said close via on four sides. If an equal potential via is detected, then the layout of the semiconductor integrated circuit is corrected by deleting the close via.

### FIELD OF THE INVENTION

The present invention in general relates to a method and apparatus with which layouts of semiconductor integrated circuits can be automatically designed based on predetermined designing rules. More specifically, this invention relates to a method and apparatus for designing semiconductor integrated circuits capable of automatically correcting the high density of vias.

### BACKGROUND OF THE INVENTION

In recent years, a small quantity of may types of semiconductor integrated circuits tend to be manufactured and the layout of the semiconductor integrated circuit is automatically designed to meet demand for shortening a development period using CAD. In the automatic layout design for semiconductor integrated circuits, transistor elements, resistance elements, capacity elements and the like are arranged and these elements are automatically interconnected by wirings. However, due to a limit to semiconductor integration, it is required that wirings meet a designing rules.

Meanwhile, in semiconductor integrated circuit manufacturing steps, multiple layers are provided and multilayer wirings are provided accordingly. In this case, in the semiconductor integrated circuit, the respective layers are connected by way of a through hole penetrating insulating layers. Since it is difficult to accurately form the through hole depending on a position at which the through hole is designed to be located, such vias as to allow the positional error of the through hole within a certain range are provided to connect wirings. The via occupies a wide rectangular area compared with wiring width and a metal layer is formed on the entire surface of this area. With this constitution, it is possible to ensure connecting upper and lower wiring layers whichever position the through hole is formed in the rectangular area of this via. It is noted that this via is required to meet the designing rules, as well.

In the meantime, in the conventional semiconductor integrated circuit automatic layout design stated above, there are cases where vias are arranged closely in a design phase. If the vias meet the designing rules but are arranged closely, the reliability of forming vias disadvantageously deteriorates and the reliability of the semiconductor integrated circuit thereby disadvantageously deteriorates.

In this case, a conventional apparatus for automatically designing the layout of a semiconductor integrated circuit cannot avoid the high density of vias. Due to this, after the completion of the automatic layout design, a process for correcting the high density of vias is carried out manually. As a result, although the layout of the semiconductor integrated circuit is automatically designed, it disadvantageously takes time and labor.

### SUMMARY OF THE INVENTION

It is an object of the present invention to provide a method and apparatus for capable of designing a highly reliable semiconductor integrated circuit in which the high density of vias are automatically avoided, and capable of further reducing time and labor required to design the layout of the semiconductor integrated circuit.

According to one aspect of the present invention, layout of a semiconductor integrated circuit is automatically designed based on the predetermined designing rules. Then, vias are detected from information about the layout and a close via surrounded by vias on four sides is detected. Then, a via equal in potential to the close via is detected from the vias surrounding the close via on the four sides. Finally, if a via equal in potential to the close via is detected, then the close via is deleted. Therefore, vias can be laid out in such a manner that they do not concentrate at one place.

According to another aspect of the present invention, layout of a semiconductor integrated circuit is automatically designed based on the predetermined designing rules. Then, vias are detected from information about the layout and a close via surrounded by vias on three sides is detected. Then, a via equal in potential to the close via is detected from the vias surrounding the close via on the three sides. Finally, if a via equal in potential to the close via is detected, then the close via is deleted and a wiring connected to the close via is extended from a position of the close via toward a position of the via equal in potential to connect the wiring to the equal potential via. Therefore, vias can be laid out in such a manner that they do not concentrate at one place.

According to still another aspect of the present invention, layout of a semiconductor integrated circuit is automatically designed based on the predetermined designing rules. Then, vias are detected from information about the layout and a close via surrounded by vias on three sides is detected. Then, a via equal in potential to the close via is detected from the vias surrounding the close via on the three sides. Finally, if a via equal in potential to the close via is not detected, then the close via is moved to in a direction in which no via exists. Therefore, vias can be laid out in such a manner that they do not concentrate at one place.

According to still another aspect of the present invention, layout of a semiconductor integrated circuit is automatically designed based on the predetermined designing rules. Then, vias are detected from information about the layout and a close via surrounded by vias on three or four sides is detected. Then, a via equal in potential to the close via is detected from the vias surrounding the close via on the three or four sides. Finally, a layout is corrected by, a) deleting said close via if said close via is surrounded by vias on four sides and if an equal potential via is detected, or b) deleting said close via and extending a wiring connected to the close via from a position of the close via toward a position of said equal potential via to connect the wiring to said equal potential via if said close via is surrounded by vias on three sides and if an equal potential via is detected, or c) moving said close via in a direction in which no via exists if said close via is surrounded by vias on three sides and if an equal potential via is not detected. Therefore, vias can be laid out in such a manner that they do not concentrate at one place.

Other objects and features of this invention will become apparent from the following description with reference to the accompanying drawings.

### BRIEF DESCRIPTION OF THE DRAWINGS

FIG. 1 is a block diagram showing the constitution of a semiconductor integrated circuit design apparatus in a first embodiment according to the present invention;

FIG. 2 is a flow chart showing correction processing procedures for correcting a layout design by using a semiconductor integrated circuit design method in the first embodiment according to the present invention;

FIG. 3 shows one example of a layout design to which the first embodiment according to the present invention is applied;

FIG. 4 shows one example of the result of the layout design shown in FIG. 3 to which the first embodiment according to the present invention is applied;

FIG. 5 is a block diagram showing the constitution of a semiconductor integrated circuit design apparatus in a second embodiment according to the present invention;

FIG. 6 is a flow chart showing correction processing procedures for correcting a layout design by using a semiconductor integrated circuit design method in the second embodiment according to the present invention;

FIG. 7 shows one example of a layout design to which the second embodiment according to the present invention is applied;

FIG. 8 shows one example of the result of the layout design shown in FIG. 7 to which the second embodiment according to the present invention is applied;

FIG. 9 is a block diagram showing the constitution of a semiconductor integrated circuit design apparatus in a third embodiment according to the present invention;

FIG. 10 is a flow chart showing correction processing procedures for correcting a layout design by using a semiconductor integrated circuit design method in the third embodiment according to the present invention;

FIG. 11 shows one example of a layout design to which the third embodiment according to the present invention is applied;

FIG. 12 shows one example of the result of the layout design shown in FIG. 11 to which the third embodiment according to the present invention is applied;

FIG. 13 is a block diagram showing the constitution of a semiconductor integrated circuit design apparatus in a fourth embodiment according to the present invention; and

FIG. 14 is a flow chart showing correction processing procedures for correcting a layout design by using a semiconductor integrated circuit design method in the fourth embodiment according to the present invention.

### DESCRIPTION OF THE PREFERRED EMBODIMENTS

Preferred embodiments of a method and apparatus for designing semiconductor integrated circuits will be described hereinafter with reference to the accompanying drawings.

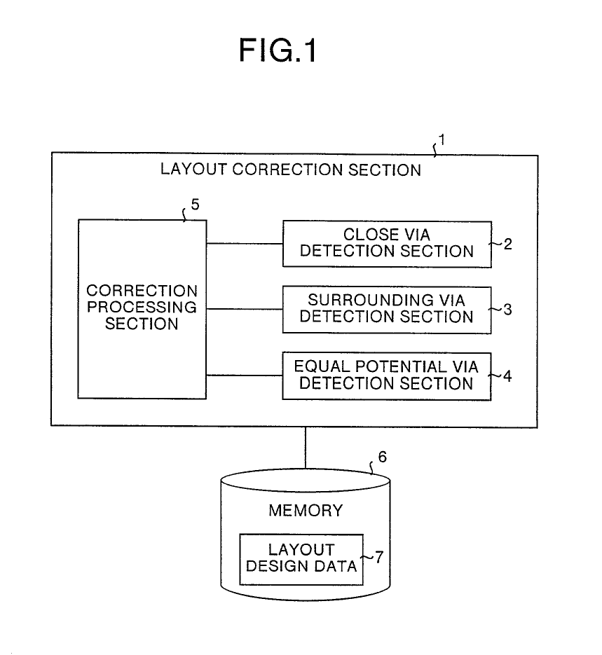

FIG. 1 is a block diagram showing the constitution of a semiconductor integrated circuit design apparatus according to a first embodiment of the present invention. In FIG. 1, the semiconductor integrated circuit design apparatus has a layout correction section 1 and a memory 6. The layout correction section 1 has a close via detection section 2 detecting a close via surrounded by vias on four sides from layout design data 7 held by the memory 6, a surrounding via detection section 3 detecting vias surrounding the close via on the four sides, an equal potential via detection section 4 detecting a via equal in potential to the close via from the surrounding vias, and a correction processing section 5 conducting a processing for correcting the close via and wirings relating to the close via.

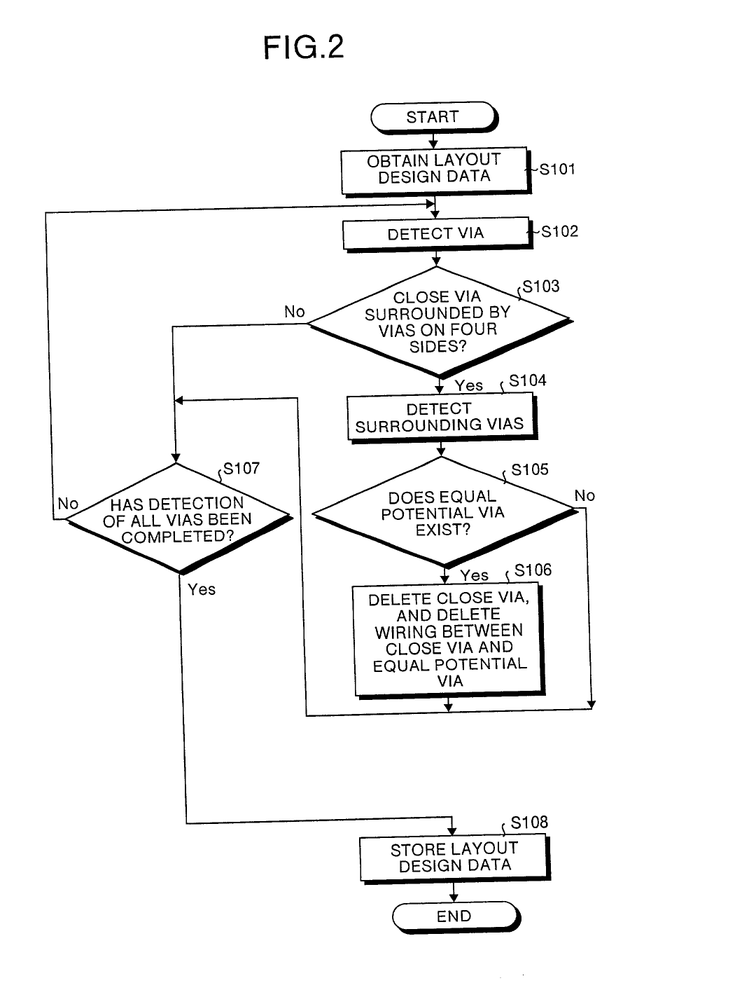

A close via correction processing performed by the layout correction section 1 will be described with reference to a flow chart shown in FIG. 2. The layout correction section 1 obtains layout design data 7 held by the memory 6 and designed based on a designing rules (Step S101). Then, the close via detection section 2 detects a via from the layout design data 7 (Step S102), and judges whether or not the detected via is a close via surrounded by vias on four sides (Step S103). If the via is a close via (‘YES’ in the step S103), the surrounding via detection section 3 detects vias surrounding the close via (Step S104). The equal potential via detection section 4 judges whether or not there exists a via equal in potential to the close via (Step S105).

If there exists a via equal in potential to the close via (‘YES’ in the step S105), the correction processing section 5 conducts a correction processing including deleting the close via, deleting a wiring between the close via and the equal potential via (Step S106) and moves to a step S107. If there does not exist a via equal in potential to the close via (‘NO’ in the step S105), then the correction processing section 5 does not conduct a correction processing, moves to the step S107 and conducts a correction processing for the next close via.

On the other hand, if there does not exist a close via (‘NO’ in the step S103), it is judged whether or not the detection of all vias has been completed (Step S107). If the detection of all vias has not been completed (‘NO’ in the step S107), the correction processing section 5 moves to the step S102 and conducts a correction processing for the next via. If the detection of all vias has been completed (‘YES’ in the step S107), the layout design data for which the correction processing has been conducted is stored in the memory 6 (Step S108) and the processing is terminated. Although the wiring between the close via and the via equal in potential to the close via is deleted in the step S106, this deletion may be conducted according to the necessity. In the processing procedures shown in FIG. 2, a correction processing is conducted every time a via is detected. Alternatively, it is possible that before conducting a correction processing, all vias are detected, close vias are detected and then a correction processing for all the close vias is conducted all at once.

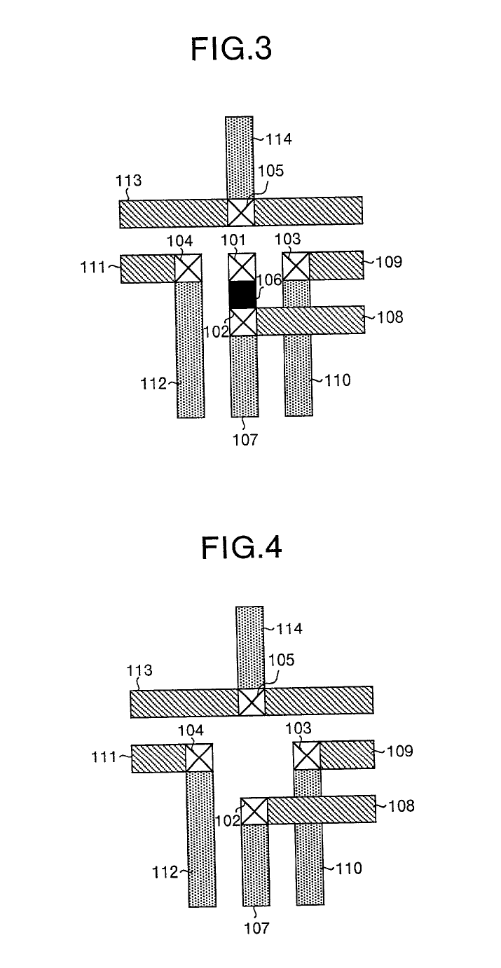

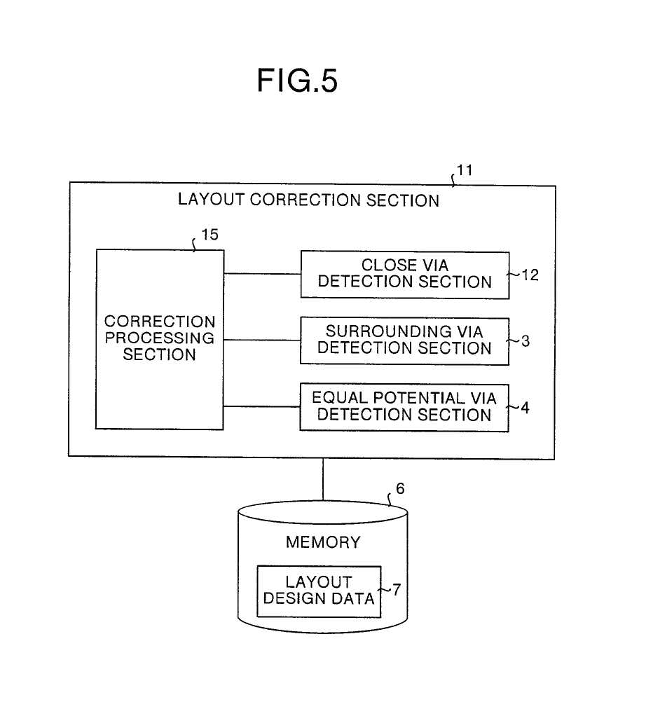

Now, with reference to FIGS. 3 and 4, an example of the correction processing for the close via will be described. FIG. 3 shows a wiring pattern in the vicinity of the close via before the correction processing. FIG. 4 shows a wiring pattern in the vicinity of the close via after the correction processing. In FIG. 3, a close via 101 is surrounded by vias 102 to 105 on four sides. Wirings 108, 109, 111 and 113 are provided on the same layer, i.e., an upper layer. Wirings 107, 110, 112 and 114 are provided on the same layer, i.e., a lower layer different from the upper layer. A wiring 106 is a wiring resultant from overlap of an upper layer wiring with a lower layer wiring.

If the equal potential via detection section 4 detects a via 102 equal in potential to the via 101, then the correction processing section 5 conducts a correction processing including deleting the close via 101 and deleting the wiring 106 to thereby correct the wiring pattern to that shown in FIG. 4. In this case, the close via 101 is a via connecting a wiring between the upper and lower layers of the wiring 106. Since the via 102 equal in potential to the via 101 has the same function as that of the close via 101, no logical problem occurs even if deleting the close via 101. The wiring 106 may not be necessarily deleted. In this embodiment, the wiring is deleted because the wiring pattern becomes redundant.

In the first embodiment, it is possible to delete a close via surrounded by vias on four sides from layout design data. Due to this, in a semiconductor process for manufacturing a semiconductor integrated circuit based on the layout design data, no close vias exist and errors resulting from the close vias are reduced, thereby making it possible to provide a semiconductor integrated circuit having high reliability.

It is assumed that the close via is surrounded by vias on four sides in the above-described first embodiment. However, a close via may be surrounded by vias only on three sides. This case will be explained below as a second embodiment of the present invention.

FIG. 5 is a block diagram showing the constitution of a semiconductor integrated circuit design apparatus according to the second embodiment according to the present invention. In FIG. 2, a close via detection section 12 in a layout correction section 11 corresponds to the close via detection section 2 and detects a close via surrounded by vias on three sides. A correction processing section 15 corresponds to the correction processing section 5 and conducts a correction processing for deleting the close via surrounded by vias on three sides. The remaining constituent elements are the same as those in the first embodiment and denoted by the same reference symbols as those in the first embodiment.

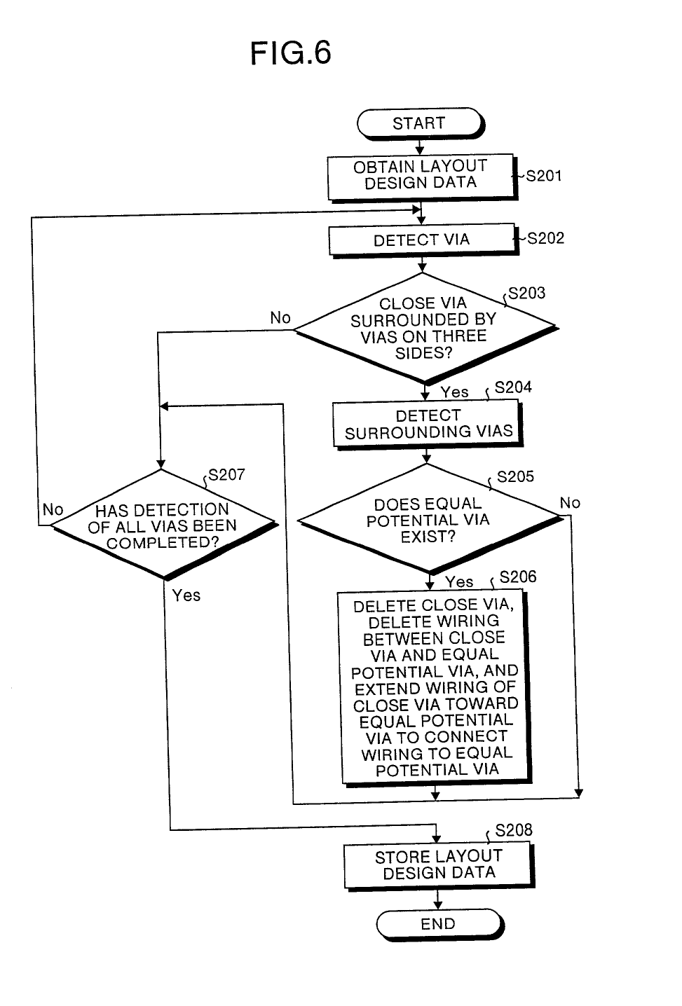

A close via correction processing performed by the layout correction section 11 will be described with reference to a flow chart shown in FIG. 6. First, the layout correction section 11 obtains layout design data 7 held by a memory 6 and designed based on a designing rules (Step S201). Then, the close via detection section 12 detects a via from the layout design data 7 (Step S202) and judges whether or not the detected via is a close via surrounded by vias on three sides (Step S203). If the detected via is a close via (‘YES’ in the step S203), a surrounding via detection section 3 detects surrounding vias which surround the close via on three sides (Step S204). An equal potential via detection section 4 judges whether or not there exists a via equal in potential to the close via (Step S205).

If there exists a via equal in potential to the close via (‘YES’ in the step S205), the correction processing section 15 conducts a correction processing including deleting the close via, deleting a wiring connecting this close via to the equal potential via, extending the wiring of this close via toward the equal potential via and connecting the wiring of the close via to the equal potential via (Step S206), and moves to a step S207. If there does not exist a via equal in potential to the close via (‘NO’ in the step S205), the correction processing section 15 does not conduct a correction processing, moves to the step S207 and conducts a correction processing for the next close via.

On the other hand, if there does not exist a close via (‘NO’ in the step S203), it is judged whether or not the detection of all vias has been completed (Step S207). If the detection of all vias has not been completed (‘NO’ in the step S207), the correction processing section 15 moves to the step S202 and conducts a correction processing for the next via. If the detection of all vias has been completed (‘YES’ in the step S207), the layout design data for which the correction processing has been conducted is stored in the memory 6 (Step S208) and a series of processings are finished. In the processing procedures shown in FIG. 5, a correction processing is conducted every time a via is detected. Alternatively, it is possible that before conducting a correction processing, all vias are detected, close vias are detected and then a correction processing for all the close vias is conducted at once.

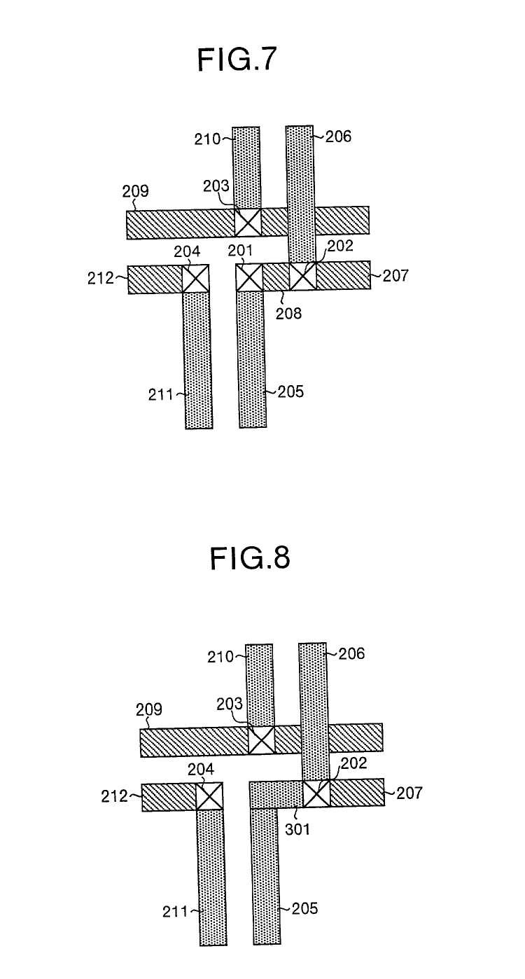

An example of the close via correction processing will be described with reference to FIG. 7 and FIG. 8. FIG. 7 shows a wiring pattern in the vicinity of a close via before a correction processing. FIG. 8 shows a wiring pattern in the vicinity of the close via after the correction processing. In FIG. 7, a close via 201 is surrounded by vias 202 to 204 on three sides. Wirings 205, 206, 210 and 211 are provided on the same layer, i.e., an upper layer. Wirings 207, 208, 209 and 212 are provided on the same layer, i.e., a lower layer different from the upper layer.

If the equal potential via detection section 4 detects a via 202 equal in potential to the close via 201, the correction processing section 15 conducts a correction processing including deleting the close via 201, forming a wiring 301 which is the extension of the wiring 205 of the close via 201 toward the equal potential via 202 and connecting the wiring 205 to the via 202, to thereby correct the wiring pattern to that shown in FIG. 8. In this case, the close via 201 is a via connecting the wiring 205 on the upper layer to the wiring 208 on the lower layer. By adding the wiring 208 to the upper layer side, the via 202 substitutes for the close via 201. Therefore, even if the close via 201 is deleted, no logical problem occurs. The wiring 208 may not necessarily be deleted. In this embodiment, the wiring is deleted because the wiring pattern becomes redundant.

In the second embodiment described above, it is possible to delete a close via surrounded by vias on three sides from layout design data. Due to this, in a semiconductor process for manufacturing a semiconductor integrated circuit based on the layout design data, no close vias exist and errors resulting from the close vias are reduced, thereby making it possible to provide a semiconductor integrated circuit having high reliability.

In the above-described second embodiment, a close via is deleted if there exists a via equal in potential to the close via in the vias which surround the close via on three sides. However, the correction processing can be conducted even if an equal potential via does not exist. This case will be explained below as a third embodiment of the present invention.

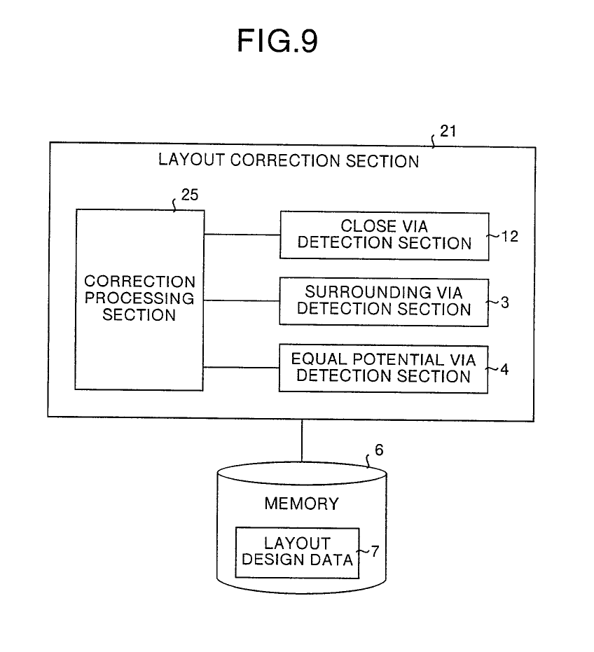

FIG. 9 is a block diagram showing the constitution of a semiconductor integrated circuit design apparatus according to the third embodiment according to the present invention. In FIG. 9, a correction processing section 25 in a layout correction section 21 corresponds to the correction processing section 15 and conducts a correction processing for deleting a via surrounded by vias on three sides. The remaining constituent elements are the same as those in the first embodiment and denoted by the same reference symbols as those in the first embodiment.

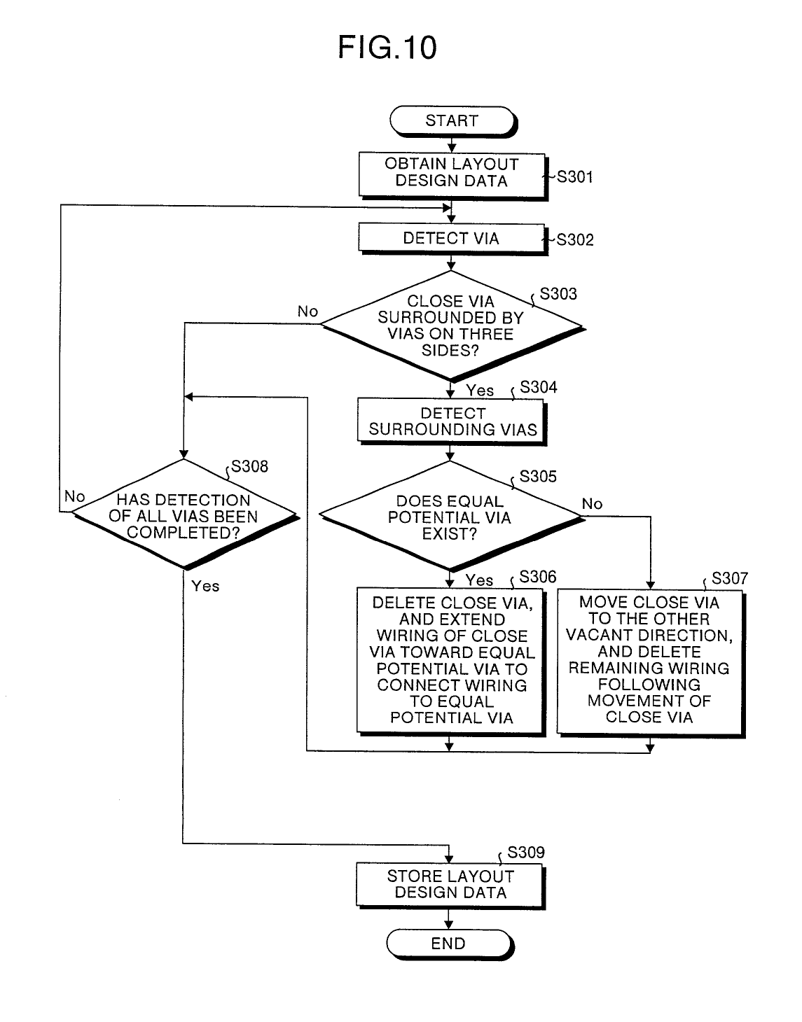

A close via correction processing performed by the layout correction section 21 will be described with reference to a flow chart shown in FIG. 10. First, the layout correction section 21 obtains layout design data 7 held by a memory 6 and designed based on a designing rules (Step S301). Then, a close via detection section 12 detects a via from the layout design data 7 (Step S302) and judges whether or not the detected via is a close via surrounded by vias on three sides (Step S303). If the detected via is a close via (‘YES’ in the step S303), a surrounding via detection section 3 detects surrounding vias which surround the close via on three sides (Step S304). An equal potential via detection section 4 judges whether or not there exists a via equal in potential to the close via (Step S305).

If there exists a via equal in potential to the close via (‘YES’ in the step S305), the correction processing section 25 conducts a correction processing including deleting this close via, deleting a wiring connecting the close via to the equal potential via, extending the wiring of the close via toward the equal potential via and connecting the wiring of the close via to the equal potential via (Step S306) and moves to a step S308. The processing of the step S306 is the same as that in the second embodiment.

If there does not exist a via equal in potential to the close via (‘NO’ in the step S305), the correction processing section 25 conducts a correction processing including moving the close via to the other vacant direction in which no surrounding via exists, avoiding the close state of the close via and deleting the remaining wiring following the movement of the close via (Step S307) and moves to a step S308.

On the other hand, if there does not exist a close via (‘NO’ in the step S303), it is judged whether or not the detection of all vias has been completed (Step S308). If the detection of all vias has not been completed (‘NO’ in the step S308), the correction processing section 25 moves to the step S302 and conducts a correction processing for the next via. If the detection of all vias has been completed (‘YES’ in the step S308), the layout design data for which the correction processing has been conducted is stored in the storage section 6 (Step S309) and a series of processings are finished. In the processing procedures shown in FIG. 10, a correction processing is conducted every time a via is detected. Alternatively, it is possible that before conducting a correction processing, all vias are detected, close vias are detected and then a correction processing for all the close vias is conducted at once.

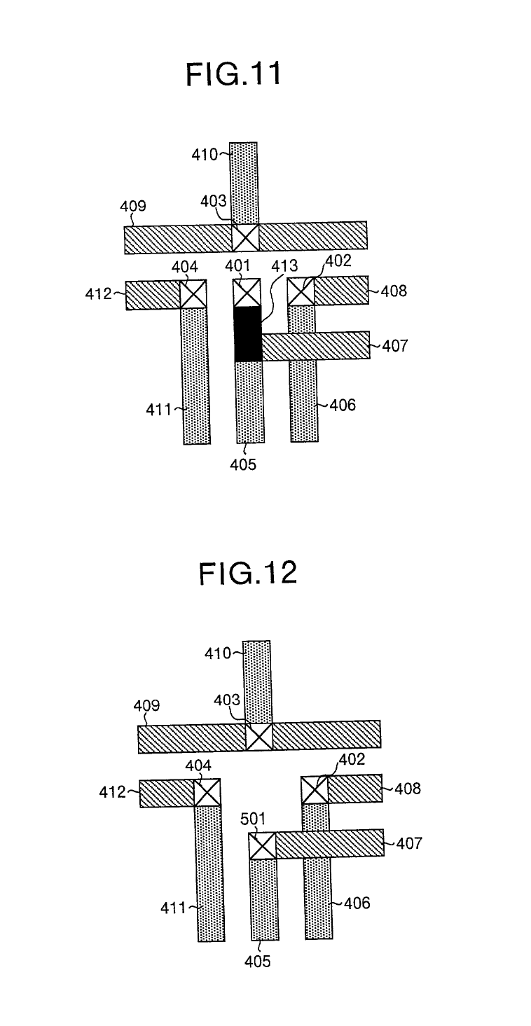

An example of the close via correction processing will be described with reference to FIG. 11 and FIG. 12. FIG. 11 shows a wiring pattern in the vicinity of a close via before a correction processing. FIG. 12 shows a wiring pattern in the vicinity of the close via after the correction processing. In FIG. 11, a close via 401 is surrounded by vias 402 to 404 on three sides. Wirings 405, 406, 410 and 411 are provided on the same layer, i.e., an upper layer. Wirings 407, 408, 409 and 412 are provided on the same layer, i.e., a lower layer different from the upper layer. A wiring 413 is a wiring resulting from overlap of an upper layer wiring with a lower layer wiring.

The surrounding vias 402 to 404 are not equal in potential to the close via 401. Due to this, the correction processing section 25 moves the close via 401 from the present position to a direction that there dose not exist the surrounding vias 402 to 404 (downward direction in FIG. 11), avoids the close state of the close via 401 and consequently forms the close via 401 into a via 501 as shown in FIG. 12. Further, following the movement of the close via 401, the remaining wiring 413 is deleted. In this case, the close via 401 connects a wiring between the upper and lower layers of the wiring 413. Even if the wirings of the upper and lower layers are connected to each other at the position of the via 501, no logical problem occurs. The wiring 413 may not necessarily be deleted. In this embodiment, the wiring 413 is deleted because the wiring pattern becomes redundant.

Thus, even if the surrounding vias are not equal in potential to the close via, it is possible to avoid the close state of the close via surrounded by the vias on three sides from the layout design data. Therefore, in a semiconductor process for manufacturing a semiconductor integrated circuit based on the layout design data, no close vias exist and errors resulting from the close vias are reduced, thereby making it possible to provide a semiconductor integrated circuit having high reliability.

The correction processing explained in connection with the above-described first to third embodiments may be combined to eliminate a concentration of vias. This case will be explained below as a fourth embodiment of the present invention.

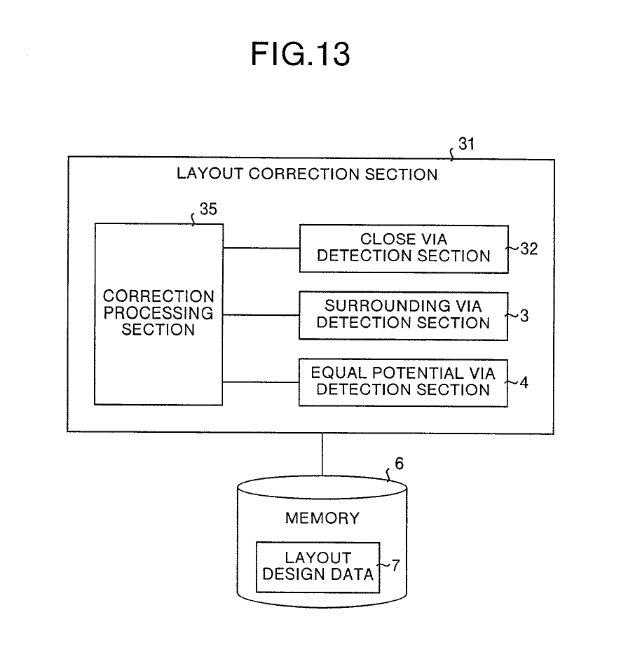

FIG. 13 is a block diagram showing the constitution of a semiconductor integrated circuit design apparatus according to the fourth embodiment according to the present invention. In FIG. 13, a close via detection section 32 in a layout correction section 31 corresponds to the close via detection sections 2 and 12, and detects a close via in a state in which the close via is surrounded by vias on three or four sides. A correction processing section 35 corresponds to the correction processing sections 2 and 25 and conducts a correction processing for avoiding the close state of the close via surrounded by vias on three or four sides. The remaining constituent elements are the same as those in the first embodiment and denoted by the same reference symbols as those in the first embodiment.

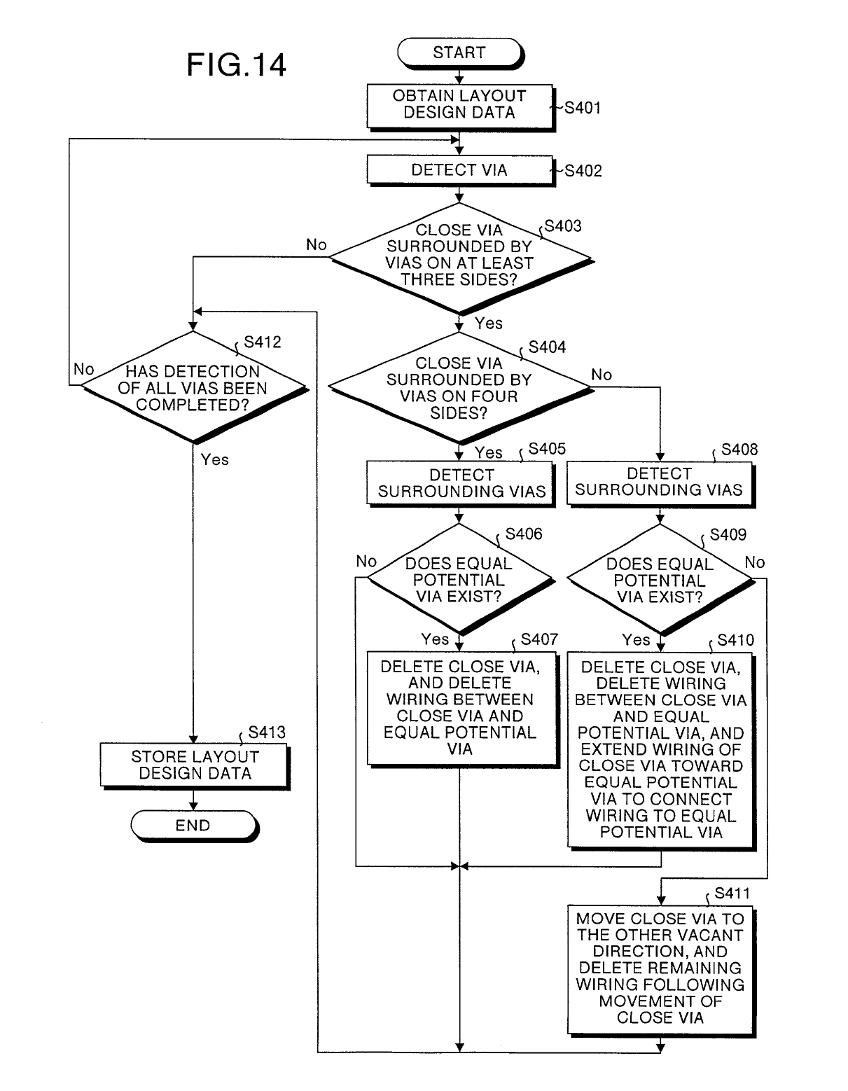

The close via correction processing performed by the layout correction section 31 will be described with reference to a flow chart shown in FIG. 14. The layout correction section 31 obtains layout design data 7 held by a memory 6 and designed based on a designing rules (Step S401). Then, the close via detection section 32 detects a via from the layout design data 7 (Step S402) and judges whether or not the detected via is a close via surrounded by vias on at least three sides (Step S403). If the detected via is a close via surrounded by vias on at least three sides (‘YES’ in the step S403), the close via detection section 32 further judges whether or not the detected via is a close via surrounded by vias on four sides (Step S404).

If the detected via is a close via surrounded by vias on four sides (‘YES’ in the step S404), a surrounding via detection section 3 detects the surrounding vias which surround the close via on four sides (Step S405). An equal potential detection section 4 judges whether or not there exists a via equal in potential to the close via (Step S406).

If there exists a via equal in potential to the close via (‘YES’ in the step S406), the correction processing section 35 conducts a correction processing including deleting this close via and deleting a wiring connecting the close via to the equal potential via (Step S407) and moves to a step S412. If there does not exist a via equal in potential to the close via (‘NO’ in the step S406), the correction processing section 35 does not conduct a correction processing, moves to a step S412 and conducts a correction processing for the next close via. The processing of the step S407 is the same as that in the first embodiment.

On the other hand, in the correction processing section 35, if the close via is surrounded by via on only three sides (‘NO’ in the step S404), the surrounding via detection section 3 further detects surrounding vias surrounding the close via on four sides (Step S408). The equal potential via detection section 4 judges whether or not there exists a via equal in potential to the close via (Step S409).

If there exists a via equal in potential to the close via (‘YES’ in the step S409), the correction processing section 35 conducts a correction processing including deleting this close via, deleting a wiring connecting the close via to the equal potential vial hole, extending the wiring of the close via toward the equal potential via and moving the wiring of the close via to the equal potential via (Step S410), and moves to a step S412. The processing of the step S410 is the same as that in the second embodiment.

If there does not exist a via equal in potential to the close via (‘NO’ in the step S409), the correction processing section 35 conducts a correction processing including moving the close via to the other vacant direction in which no surrounding via exists, avoiding the close state of the close via and deleting the remaining wiring following the movement of the close via (Step S411) and moves to a step S412. The processing of the step S411 is the same as that in the third embodiment.

On the other hand, if there does not exist a close via (‘NO’ in the step S403), it is judged whether or not the detection of all vias has been completed (Step S412). If the detection of all vias has not been completed (‘NO’ in the step S412), the correction processing section 35 moves to the step S402 and conducts a correction processing for the next via. If the detection of all vias has been completed (‘YES’ in the step S412), the layout design data for which the correction processing has been conducted is stored in the memory 6 (Step S413) and a series of processings are finished. In the processing procedures shown in FIG. 14, a correction processing is conducted every time a via is detected. Alternatively, it is possible that before conducting a correction processing, all vias are detected, close vias are detected and then a correction processing is conducted for all the close vias at once.

Thus, it is possible to avoid the close state of the close via surrounded by vias on at least three sides. Due to this, in a semiconductor process for manufacturing a semiconductor integrated circuit based on the layout design data, no close vias exist and errors resulting from the close vias are reduced, thereby making it possible to provide a semiconductor integrated circuit having high reliability.

As described so far, according to one aspect of the present invention, layout of a semiconductor integrated circuit is automatically designed based on the predetermined designing rules. Then, vias are detected from information about the layout and a close via surrounded by vias on four sides is detected. Then, a via equal in potential to the close via is detected from the vias surrounding the close via on the four sides. Finally, if a via equal in potential to the close via is detected, then the close via is deleted. Therefore, vias can be laid out in such a manner that they do not concentrate at one place. Accordingly, in a semiconductor process for manufacturing a semiconductor integrated circuit based on the layout design data, no close vias exist and errors resulting from the close vias are reduced, thereby making it advantageously possible to provide a semiconductor integrated circuit having high reliability.

According to another aspect of the present invention, layout of a semiconductor integrated circuit is automatically designed based on the predetermined designing rules. Then, vias are detected from information about the layout and a close via surrounded by vias on three sides is detected. Then, a via equal in potential to the close via is detected from the vias surrounding the close via on the three sides. Finally, if a via equal in potential to the close via is detected, then the close via is deleted and a wiring connected to the close via is extended from a position of the close via toward a position of the via equal in potential to connect the wiring to the equal potential via. Therefore, vias can be laid out in such a manner that they do not concentrate at one place. Accordingly, in a semiconductor process for manufacturing a semiconductor integrated circuit based on the layout design data, no close vias exist and errors resulting from the close vias are reduced, thereby making it advantageously possible to provide a semiconductor integrated circuit having high reliability.

According to still another aspect of the present invention, layout of a semiconductor integrated circuit is automatically designed based on the predetermined designing rules. Then, vias are detected from information about the layout and a close via surrounded by vias on three sides is detected. Then, a via equal in potential to the close via is detected from the vias surrounding the close via on the three sides. Finally, if a via equal in potential to the close via is detected, then the close via is moved to in a direction in which no via exists. Therefore, Therefore, vias can be laid out in such a manner that they do not concentrate at one place. Accordingly, in a semiconductor process for manufacturing a semiconductor integrated circuit based on the layout design data, no close vias exist and errors resulting from the close vias are reduced, thereby making it advantageously possible to provide a semiconductor integrated circuit having high reliability.

According to still another aspect of the present invention, layout of a semiconductor integrated circuit is automatically designed based on the predetermined designing rules. Then, vias are detected from information about the layout and a close via surrounded by vias on three or four sides is detected. Then, a via equal in potential to the close via is detected from the vias surrounding the close via on the three or four sides. Finally, a layout is corrected by, a) deleting said close via if said close via is surrounded by vias on four sides and if an equal potential via is detected, or b) deleting said close via and extending a wiring connected to the close via from a position of the close via toward a position of said equal potential via to connect the wiring to said equal potential via if said close via is surrounded by vias on three sides and if an equal potential via is detected, or c) moving said close via in a direction in which no via exists if said close via is surrounded by vias on three sides and if an equal potential via is not detected. Therefore, Therefore, vias can be laid out in such a manner that they do not concentrate at one place. Accordingly, in a semiconductor process for manufacturing a semiconductor integrated circuit based on the layout design data, no close vias exist and errors resulting from the close vias are reduced, thereby making it advantageously possible to provide a semiconductor integrated circuit having high reliability.

Further, wiring between the close via and the equal potential via , or wiring between the close via and a via resulting from movement of the close via is deleted. Thus, redundant wiring is reduced.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A semiconductor integrated circuit design method comprising:
an automatic design step of automatically designing layout of the semiconductor integrated circuit based on predetermined designing rules;
a close via detection step of detecting vias based on information about the layout designed and detecting whether there exists a close via which is a via surrounded by vias on four sides;
an equal potential detection step of detecting whether there exists an equal potential via, which equal potential via is a via having a potential equal to the potential of said close via, in said vias that surround said close via on four sides; and
if an equal potential via is detected, then a layout correction step of making a layout correction by deleting said close via.

2. The semiconductor integrated circuit design method according to claim 1,
wherein the layout correction step further includes deleting a wiring between said close via and said equal potential via, or deleting a wiring between said close via and a via resulting from movement of the close via.

3. A semiconductor integrated circuit design method comprising:
an automatic design step of automatically designing layout of the semiconductor integrated circuit based on predetermined designing rules;
a close via detection step of detecting vias based on information about the layout designed and detecting whether there exists a close via which is a via surrounded by vias on three sides;
an equal potential detection step of detecting whether there exists an equal potential via, which equal potential via is a via having a potential equal to the potential of said close via, in said vias that surround said close via on three sides; and
if an equal potential via is detected, then a layout correction step of making a layout correction by deleting said close via and extending a wiring connected to the close via from a position of the close via toward a position of said equal potential via to connect the wiring to said equal potential via.

4. The semiconductor integrated circuit design method according to claim 3,
wherein the layout correction step further includes deleting a wiring between said close via and said equal potential via, or deleting a wiring between said close via and a via resulting from movement of the close via.

5. A semiconductor integrated circuit design method comprising:
an automatic design step of automatically designing layout of the semiconductor integrated circuit based on predetermined designing rules;
a close via detection step of detecting vias based on information about the layout designed and detecting whether there exists a close via which is a via surrounded by vias on three sides;
an equal potential detection step of detecting whether there exists an equal potential via, which equal potential via is a via having a potential equal to the potential of said close via, in said vias that surround said close via on three sides; and
if an equal potential via is not detected, then a layout correction step of making a layout correction by moving said close via in a direction in which no via exists.

6. The semiconductor integrated circuit design method according to claim 5,
wherein the layout correction step further includes deleting a wiring between said close via and said equal potential via, or deleting a wiring between said close via and a via resulting from movement of the close via.

7. A semiconductor integrated circuit design method comprising:
an automatic design step of automatically designing layout of the semiconductor integrated circuit based on predetermined designing rules;
a close via detection step of detecting vias based on information about the layout designed and detecting whether there exists a close via which is a via surrounded by vias on three or four sides;
an equal potential detection step of detecting whether there exists an equal potential via, which equal potential via is a via having a potential equal to the potential of said close via, in said vias that surround said close via on three or four sides; and
a layout correction step of making a layout correction by,
a) deleting said close via if said close via is surrounded by vias on four sides and if an equal potential via is detected, or
b) deleting said close via and extending a wiring connected to the close via from a position of the close via toward a position of said equal potential via to connect the wiring to said equal potential via if said close via is surrounded by vias on three sides and if an equal potential via is detected, or
c) moving said close via in a direction in which no via exists if said close via is surrounded by vias on three sides and if an equal potential via is not detected.

8. The semiconductor integrated circuit design method according to claim 7,
wherein the layout correction step further includes deleting a wiring between said close via and said equal potential via, or deleting a wiring between said close via and a via resulting from movement of the close via.

9. A semiconductor integrated circuit design apparatus for automatically designing a layout of a semiconductor integrated circuit based on predetermined designing rules, the apparatus comprising:
a close via detection unit detects vias based on information about the layout designed and detecting whether there exists a close via which is a via surrounded by vias on four sides;
an equal potential detection unit which detects whether there exists an equal potential via, which equal potential via is a via having a potential equal to the potential of said close via, in said vias that surround said close via on four sides; and
if an equal potential via is detected, then a layout correction unit which makes a layout correction by deleting said close via.

10. A semiconductor integrated circuit design apparatus according to claim 9,
wherein said layout correction unit deletes a wiring between said close via and said equal potential via, or deletes a wiring between said close via and a via resulting from movement of the close via.

11. A semiconductor integrated circuit design apparatus for automatically designing a layout of a semiconductor integrated circuit based on predetermined designing rules, the apparatus comprising:
a close via detection unit which detects vias based on information about the layout designed and detecting whether there exists a close via which is a via surrounded by vias on three sides;
an equal potential detection unit which detects whether there exists an equal potential via, which equal potential via is a via having a potential equal to the potential of said close via, in said vias that surround said close via on three sides; and
if an equal potential via is detected, then a layout correction unit which makes a layout correction by deleting said close via and extending a wiring connected to the close via from a position of the close via toward a position of said equal potential via to connect the wiring to said equal potential via.

12. A semiconductor integrated circuit design apparatus according to claim 11,
wherein said layout correction unit deletes a wiring between said close via and said equal potential via, or deletes a wiring between said close via and a via resulting from movement of the close via.

13. A semiconductor integrated circuit design apparatus for automatically designing a layout of a semiconductor integrated circuit based on predetermined designing rules, the apparatus comprising:
a close via detection unit which detects vias based on information about the layout designed and detecting whether there exists a close via which is a via surrounded by vias on three sides;
an equal potential detection unit which detects whether there exists an equal potential via, which equal potential via is a via having a potential equal to the potential of said close via, in said vias that surround said close via on three sides; and
if an equal potential via is not detected, then a layout correction unit which makes a layout correction by moving said close via in a direction in which no via exists.

14. A semiconductor integrated circuit design apparatus according to claim 13,
wherein said layout correction unit deletes a wiring between said close via and said equal potential via, or deletes a wiring between said close via and a via resulting from movement of the close via.

15. A semiconductor integrated circuit design apparatus for automatically designing a layout of a semiconductor integrated circuit based on predetermined designing rules, the apparatus comprising:
a close via detection unit which detects vias based on information about the layout designed and detecting whether there exists a close via which is a via surrounded by vias on three or four sides;
an equal potential detection unit which detects whether there exists an equal potential via, which equal potential via is a via having a potential equal to the potential of said close via, in said vias that surround said close via on three or four sides; and
a layout correction unit which makes a layout correction by,
a) deleting said close via if said close via is surrounded by vias on four sides and if an equal potential via is detected, or
b) deleting said close via and extending a wiring connected to the close via from a position of the close via toward a position of said equal potential via to connect the wiring to said equal potential via if said close via is surrounded by vias on three sides and if an equal potential via is detected, or
c) moving said close via in a direction in which no via exists if said close via is surrounded by vias on three sides and if an equal potential via is not detected.

16. A semiconductor integrated circuit design apparatus according to claim 15,
wherein said layout correction unit deletes a wiring between said close via and said equal potential via, or deletes a wiring between said close via and a via resulting from movement of the close via.
